(19) United States
(12) Patent Application Publication
(10) Pub. No.: US 2024/0248182 A1
(43) Pub. Date: Jul. 25, 2024

(54) METHOD OF DETECTING AND CORRECTING MULTI-PATH INTERFERENCE COMPONENT IN TOF CAMERA

(71) Applicants: SK hynix Inc., Icheon-si (KR); KOREA ADVANCED INSTITUTE OF SCIENCE AND TECHNOLOGY, Daejeon (KR)

(72) Inventors: Min Hyuk KIM, Daejeon (KR); Daniel S. Jeon, Daejeon (KR)

(21) Appl. No.: 18/532,875

(22) Filed: Dec. 7, 2023

(30) Foreign Application Priority Data
Jan. 20, 2023 (KR) 10-2023-0008689

(51) Int. Cl. G01S 7/487; G01S 7/4865; G01S 17/894

(52) U.S. Cl. CPC G01S 7/487; G01S 7/4866; G01S 17/894

(57) ABSTRACT

Detecting a multi-path interference component in a time-of-flight (ToF) camera may be performed by generating a confidence map in which a distortion area attributable to a multi-path interference component included in a reflection modulation signals is specified, where the reflection modulation signals is generated when two modulation signals emitted from a light source to a subject return to the ToF camera after being reflected by the subject. Correcting the multi-path interference component corrects distortion attributable to a multi-path interference component, which may include correcting only the distortion area specified in the confidence map. Detecting the multi-path interference component in a ToF camera includes collecting the reflection modulation signal at a plurality of different times, calculating amplitudes and offsets of the collected reflection modulation signals, determining whether a multi-path interference component is included in the reflection modulation signal, and generating the confidence map.

### CROSS-REFERENCE TO RELATED APPLICATION

The present application claims priority under 35 U.S.C. § 119(a) to Korean application number 10-2023-0008689, filed in the Korean Intellectual Property Office on Jan. 20, 2023, the entire disclosure of which is incorporated herein by reference.

### BACKGROUND

The present disclosure relates to techniques for generating a depth map by using an image collected by a time-of-flight (hereinafter referred to as a “ToF”) camera, and more particularly, to techniques for detecting a multi-path interference component in a ToF camera and techniques for correcting a multi-path interference component in a ToF camera, which can detect and compensate for a distortion phenomenon attributable to multi-path interference in image data collected by a ToF camera.

Among techniques for obtaining a three-dimensional image by using a camera, a ToF method of obtaining a depth image by measuring a time for light emitted from a light source of the ToF camera to return to the ToF camera, after being reflected by a subject, and calculating a distance between the light source and the subject based on the time is recently used a lot.

When a current semiconductor technology level is taken into consideration, it is difficult to implement a method of obtaining a depth image of a subject by using the wavelength of light that travels 30 centimeters in 1 nanosecond. For this reason, light is modulated by a signal having a specified frequency (hereinafter referred to as a “modulation signal”). The modulated signal may be a kind of light, but may be represented as a signal below.

The ToF technique may include emitting, by a light source associated with the ToF camera, a modulation signal to a subject and calculating a distance between the ToF camera and the subject by using a phase difference of a signal (hereinafter referred to as a “reflection modulation signal”) that is produced when the modulation signal is reflected by the subject and the wavelength of the modulation signal. A sinusoidal wave or a pulse may be used as the modulation signal.

When a pulse is used as a modulation signal, a plurality of reflection modulation signals that are measured at different time periods is collected. When times when reflection modulation signals were collected are different from each other, a phase difference may be present between the collected reflection modulation signals. Generation of a depth image using the intensities of the plurality of reflection modulation signals having a phase difference therebetween may be implemented using a phase restoration function known in the art.

FIG. 1 describes a depth image that has been generated by using reflection modulation signals having four different phases and a phase restoration function.

FIG. 1A illustrates a light source (modulation signal), reflected waves (reflection modulation signals), and intensities Q1 to Q4 of the reflection modulation signals that were measured at four different times Phase 1 to Phase 4. FIG. 1B illustrates a depth image that was generated by using images corresponding to the four reflection modulation signals Q1 to Q4 collected by a ToF camera and a phase restoration function.

In FIG. 1A, arrows that are indicated below the modulation signal and the reflection modulation signal may be the traveling directions of the signals, for example. It may be interpreted that the modulation signal travels from the light source that is disposed on the left side to the direction of a subject that is disposed on the right side, and the reflection modulation signal travels from the subject to the ToF camera in a reverse direction.

Since the reflection modulation signals are collected at the four different times Phase 1 to Phase 4, and each phase has the same duration as the modulation signal and is 90 degrees (π/2 radians) delayed compared to the previous phase, a phase restoration function (φ) for the intensities Q1, Q2, Q3, and Q4 of the reflection modulation signals having the four different phases may be represented as in Equation 1.

$$Ψ = {tan}^{- 1} ( \frac{Q 4 - Q 2}{Q 1 - Q 3} ) \qquad ( 1 )$$

A relation of Equation 2 is established between the intensities Q of the four reflection modulation signals illustrated in FIG. 1.

$$Q = Q 1 + Q 3 = Q 2 + Q 4 \qquad ( 2 )$$

It is preferred that the reflection modulation signal includes only a signal that returns after being directly reflected by the subject, but the reflection modulation signal may also include a signal that returns after being reflected near the subject (i.e., indirectly reflected) without directly returning to the ToF camera after being reflected by the subject, that is, a signal including a multi-path interference (MPI) component.

The confidence of a depth image that is generated using a reflection modulation signal including an MPI component may be low.

### SUMMARY

In an embodiment, a method of detecting a multi-path interference component in a time-of-flight (ToF) camera may include collecting a reflection modulation signal that returns to a light source after being reflected by a subject at a plurality of different times, when two modulation signals having different frequencies are emitted from the light source to the subject, calculating amplitude and an offset of the collected reflection modulation signal, determining whether a multi-path interference component has been included in a measured reflection modulation signal by comparing amplitude of the reflection modulation signal, which has been predicted by using a value of the offset, and amplitude of the actually measured reflection modulation signal, and generating distortion image data into which a difference between the offset and the amplitude of the measured reflection modulation signal has been incorporated, and generating a confidence map as a reciprocal number of the distortion image data.

In an embodiment, a method of correcting a multi-path interference component in a time-of-flight (ToF) camera may include collecting a reflection modulation signal that returns to a light source after being reflected by a subject from a modulation signal that is emitted from the light source to the subject, separating a direct reflection component via a direct reflection path, which is included in the reflection modulation signal, and an indirect reflection component via an indirect reflection path, which is included in the reflection modulation signal, from each other, generating a dual path model by generating a cost function including a data term and a normalization term, based on the direct reflection path and the indirect reflection path, optimizing the dual path model by calculating a plurality of variables that minimize the cost function, and generating a corrected depth map by applying the plurality of variables calculated in the calculating of the plurality of variables to a depth image including the direct reflection component and the indirect reflection component. The data term may be a term for calculating a difference between k (k is a natural number)-th frame data that is measured by a ToF camera using the direct reflection component and the indirect reflection component as a model and reconstructed k-th frame data. The normalization term may include a value that is obtained by putting together amplitude of the direct reflection path and a length of the direct reflection path, after applying a total variation (TV) algorithm to the amplitude of the direct reflection path and the length of the direct reflection path and then adding penalty constants to the amplitude of the direct reflection path and the length of the direct reflection path, respectively.

In an embodiment, a method of correcting a multi-path interference component in a time-of-flight (ToF) camera may include generating a final depth map by applying a confidence map to a depth map and an unwrapped map, wherein the depth map is generated by calculating variables that minimize a cost function including a data term and a normalization term, based on a reflection modulation signal that includes a direct reflection component and an indirect reflection component and that is generated when a modulation signal that is emitted from a light source to a subject returns to the light source, and applying the variables to the depth image including the direct reflection component and the indirect reflection component. The unwrapped map may include the direct reflection component and the indirect reflection component. The emitted modulation signal may include two different frequency signals. The confidence map may be calculated as a reciprocal number of distortion image data, after calculating amplitude and offsets of a plurality of reflection modulation signals collected at a plurality of different times, comparing amplitude of a reflection modulation signal that has been predicted by using a value of the offset and amplitude of a measured reflection modulation signal, and generating the distortion image data into which a difference between the offset and the amplitude of the measured reflection modulation signal has been incorporated.

### BRIEF DESCRIPTION OF THE DRAWINGS

FIG. 1A illustrates a reflection modulation signal captured using four different phases.

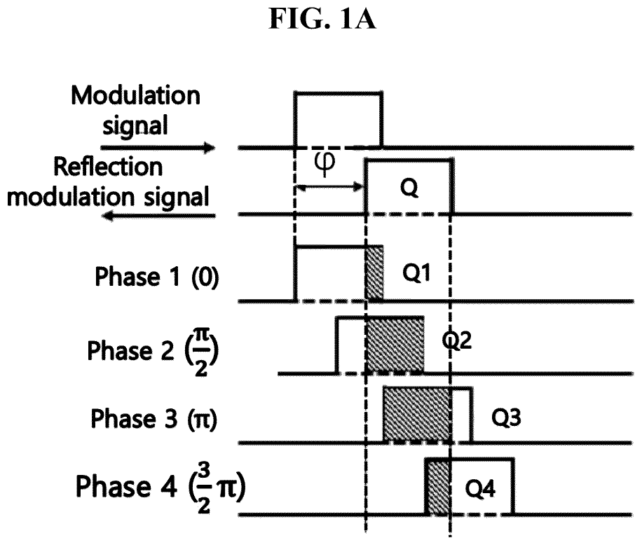

FIG. 1B illustrates depth phases that were restored using a phase restoration function.

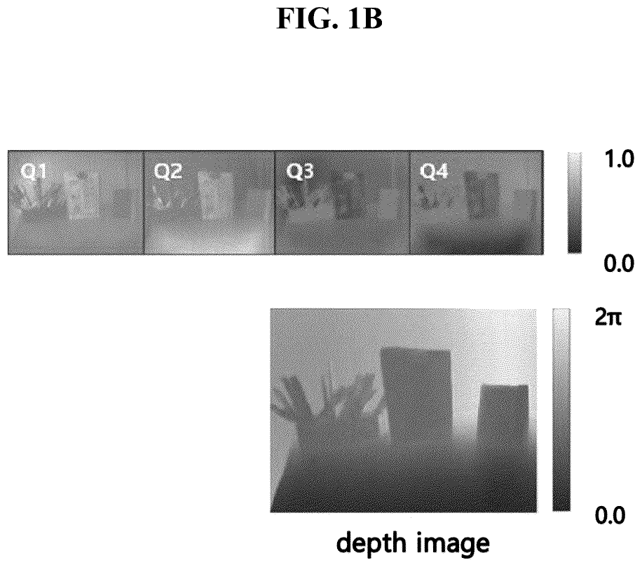

FIG. 2 illustrates a process of detecting a multi-path interference component in a ToF camera according to the present disclosure.

FIG. 3 includes images illustrating the process of FIG. 2.

FIG. 4 illustrates changes in the intensities of reflection modulation signals having four different phases according to distances of the reflection modulation signals.

FIG. 5 illustrates changes in the intensities of reflection modulation signals having four different phases according to distances of the reflection modulation signals when a multi-path interference component is present.

FIG. 6 illustrates a process of correcting a multi-path interference component in a ToF camera according to an embodiment of the present disclosure.

FIG. 7 illustrate examples of an image that was generated by a ToF camera, a direct reflection component and an indirect reflection component that are separated from each other, and a direct ground truth component and an indirect ground truth component that are separated from each other.

FIG. 8 illustrates variables that are defined between a camera and a subject.

FIG. 9 is a photo illustrating a comparison between depth images depending on whether a total variation (TV) has been applied to a dual path model according to the present disclosure.

FIG. 10 illustrates a process of correcting a multi-path interference component in a ToF camera according to another embodiment the present disclosure.

FIG. 11 includes images illustrating the process of FIG. 10.

FIG. 12 describes a general construction of the present disclosure in the form of images.

FIG. 13 includes images illustrating a comparison between the results of a process of detecting a multi-path interference component in a ToF camera and a process of correcting a multi-path interference component in a ToF camera according to embodiments of the present disclosure.

### DETAILED DESCRIPTION

In order to sufficiently understand the present disclosure, operational advantages of the present disclosure, and an object achieved by carrying out the present disclosure, reference should be made to the accompanying drawings illustrating embodiments of the present disclosure and contents described with reference to the accompanying drawings.

Hereinafter, the present disclosure is described in detail by describing embodiments of the present disclosure with reference to the attached drawings. The same reference numerals described in drawings refer to the same elements.

An embodiment of the present disclosure is directed to a process for detecting a multi-path interference component in a ToF camera, which generates a confidence map including an identified distortion area attributable to a multi-path interference component included in reflection modulation signals that are generated when two modulation signals emitted from a light source associated with the ToF camera to a subject return to the ToF camera after being reflected by the subject.

Another embodiment of the present disclosure is directed to a process for correcting a multi-path interference component in a ToF camera, which corrects distortion attributable to a multi-path interference component of a depth image by distinguishing between a direct reflected light component and an indirect reflected light component that are included in reflection modulation signals that return after being reflected by a subject.

Still another embodiment of the present disclosure is directed to a process for correcting a multi-path interference component in a ToF camera, in which the process for correcting distortion attributable to a multi-path interference component by distinguishing between a direct reflected light component and an indirect reflected light component and the process for correcting distortion attributable to a multi-path interference component by using two modulation signals have been combined.

The process for detecting and correcting a multi-path interference component in a ToF camera according to the present disclosure has advantages in that a correction area can be minimized by generating a confidence map in which an image area that is distorted by a multi-path interference component is identified and a distorted portion of an image that is received from a ToF camera can have maximum efficiency from technical, temporal, and economical aspects by applying a process for optimizing a dual path model including a direct reflection path and an indirect reflection path.

Effects which may be obtained using embodiments of the present disclosure are not limited to the aforementioned effects, and other effects not described above may be understood by a person having ordinary knowledge in the art to which the present disclosure pertains from the following description.

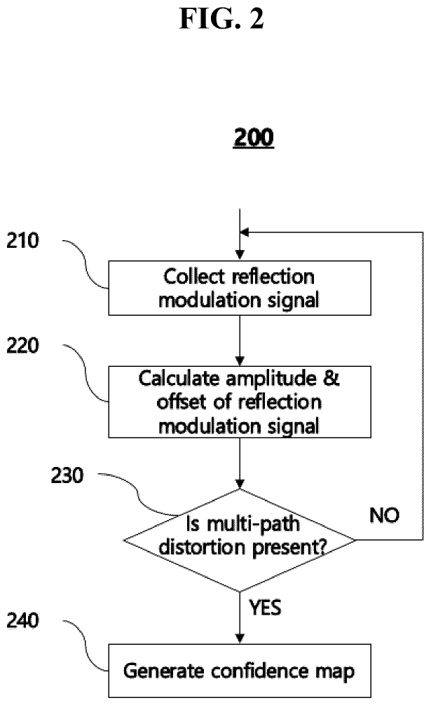

FIG. 2 is a diagram describing a process 200 for detecting a multi-path interference component in a ToF camera according to an embodiment of the present disclosure.

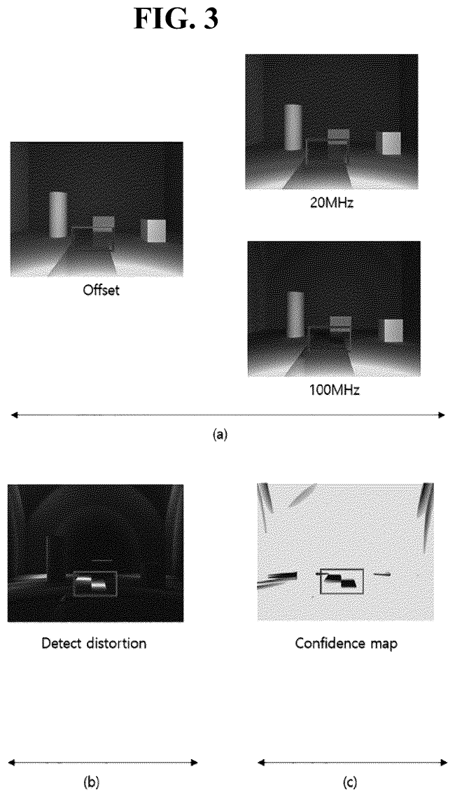

FIG. 3 includes images illustrating the process of FIG. 2.

Referring to FIGS. 2 and 3, the process 200 of detecting a multi-path interference component in a ToF camera according to the present disclosure may include a step 210 of collecting a reflection modulation signal, a step 220 of calculating an amplitude and an offset of the reflection modulation signal, a step 230 of determining multi-path distortion, and a step 240 of generating a confidence map.

In the images in FIG. 3, a square annotation in a middle part of each image denotes an area in which distortion occurred.

In step 210 of collecting the reflection modulation signal 210, two modulation signals, for example, a first modulation signal having a frequency of 20 MHz and a second modulation signal having a frequency of 100 MHz may be emitted towards a subject (not illustrated). A plurality of reflection modulation signals corresponding to the two modulation signals may be collected.

The reflection modulation signal may include four reflection modulation signals having different phases within a range that does not exceed one period (2π radians) of a modulation signal. For example, the plurality of reflection modulation signals may include four reflection modulation signals having different phases, which correspond to the first modulation signal, and four reflection modulation signals having different phases, which correspond to the second modulation signal. For convenience of description, it is assumed that the four different phases of each of the first and second modulation signals are at 0, π/2, π, and 3π/2 radians.

In the step 220 of calculating the amplitude and offset of the reflection modulation signal, amplitude and offsets of four reflection modulation signals corresponding to each of the two modulation signals may be calculated.

Equation 3 illustrates equations for calculating the amplitude and offset of the reflection modulation signal.

$$Amplitude = \frac{\sqrt{{( Q 3 - Q 1 )}^{2} + {( Q 4 - Q 2 )}^{2}}}{2} \qquad ( 3 )$$

$$Offset = \frac{Q 1 + Q 3}{2} = \frac{Q 2 + Q 4}{2} = \frac{Q 1 + Q 2 + Q 3 + Q 4}{4}$$

FIG. 3A includes an offset image of the reflection modulation signal and depth images of the two reflection modulation signals having the frequencies of 20 MHz and 100 MHZ, respectively.

Embodiments of the present disclosure make use of the fact that when a multi-path interference component is included in a reflection modulation signal, a value of the amplitude of the reflection modulation signal is changed, but the offset of the reflection modulation signal is not changed. That is, whether a collected reflection modulation signal includes distortion attributable to a multi-path interference component may be determined by using the fact that the phase and amplitude of a reflection modulation signal including a multi-path interference component are different from the phase and amplitude of a reflection modulation signal not including a multi-path interference component.

When the fact that the offset of a reflection modulation signal is not changed is used, the amplitude of a reflection modulation signal not including a multi-path interference component can be predicted. Furthermore, whether distortion attributable to a multi-path interference component has occurred can be determined by comparing the amplitude of the predicted reflection modulation signal and the amplitude of an actually collected reflection modulation signal.

In the step 230 of determining multi-path distortion, whether a measurement reflection modulation signal includes a multi-path interference component may be determined by comparing the amplitude of a predicted reflection modulation signal (hereinafter referred to as a “prediction reflection modulation signal”) and the amplitude of an actually measured reflection modulation signal (hereinafter referred to as a “measurement reflection modulation signal”) by using a value of an offset of a reflection modulation signal.

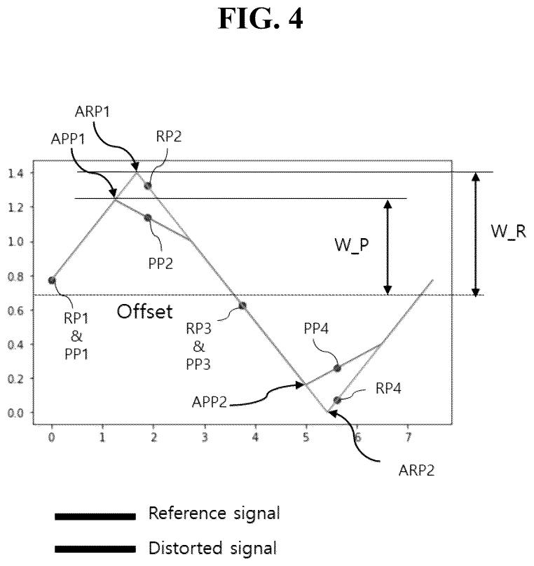

FIG. 4 illustrates changes in the intensities of reflection modulation signals having four different phases according to distances of the reflection modulation signals.

In FIG. 4, an x axis may be a change in the distances according to phases, and a y axis may be a normalized value of the intensity of a measurement reflection modulation signal in each phase. Referring to FIG. 4, it may be seen that the amplitude of a reflection modulation signal W_R not including a multi-path interference component and the amplitude of a reflection modulation signal W_P including a multi-path interference component are different from each other.

Each of four sampled reference points RP1 to RP4 for a reference signal and four sampled perturbed points PP1 to PP4 for a distorted signal may illustrate the intensities of reflection modulation signals according to four different distances. Peak points ARP1 and ARP2, or APP1 and APP2 on the upper and lower sides of FIG. 4, respectively, may be generated as illustrated in FIG. 4 by connecting lines including the four sampled points.

Referring to FIG. 4, it may be seen that if a multi-path interference component is not present in the reflection modulation signal, the amplitude and phase of the reflection modulation signal are identical with the amplitude and phase of a ground truth (hereinafter referred to as a “reference signal”) of a subject, but if the influence of a multi-path interference component is present, the amplitude and phase of the reflection modulation signal and the amplitude and phase of the reference signal are different from each other.

As described above, the offset of a reflection modulation signal is constant even when the reflection modulation signal includes a multi-path interference component. Accordingly, if a value of the offset of the reflection modulation signal is used, the intensity of a reflection modulation signal not including a multi-path interference component can be predicted.

The amplitude of a prediction reflection modulation signal and the amplitude of a measurement reflection modulation signal may be compared with each other. If the comparison indications that the amplitude of the prediction reflection modulation signal and the amplitude of the measurement reflection modulation signal are identical with each other, it may be determined that the reflection modulation signal does not include a multi-path interference component.

Referring to FIG. 4, it may be determined that the measurement reflection modulation signal includes a multi-path interference component because the amplitude W_R of the prediction reflection modulation signal and the amplitude W_P of the measurement reflection modulation signal are different from each other.

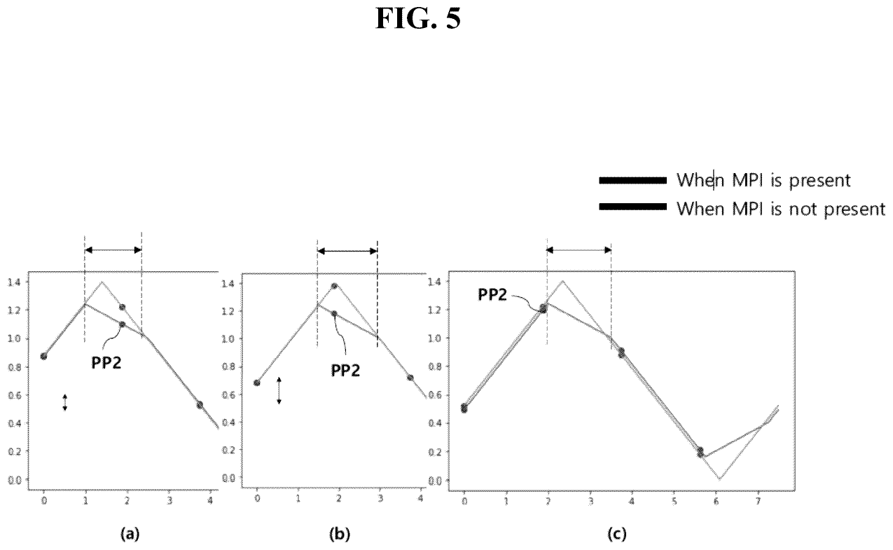

FIG. 5 illustrates changes in the intensities of reflection modulation signals having four different phases according to distances of the reflection modulation signals when a multi-path interference component is present.

As in FIG. 4, in FIG. 5, an x axis may be a change in the distance according to a phase, and a y axis may be a normalized value of the intensity of a measurement reflection modulation signal in each phase.

FIGS. 5A and 5B may illustrate a case in which the occurrence of a multi-path interference component can be detected because a sampled point PP2 of a reflection modulation signal attributable to the multi-path interference component is included in a distortion section (indicated by a bidirectional arrow) of signals generated by the multi-path interference component. FIG. 5C may illustrate a case in which a distortion signal attributable to a multi-path interference component and an original signal cannot be distinguished from each other by using only the received samples because a sampled point of a reflection modulation signal affected by a multi-path interference component is not included in a distortion section (refer to a bidirectional arrow) of signals including a multi-path interference component.

Referring to FIG. 5, it may be seen that there are the case (FIGS. 5A and 5B) in which whether a multi-path interference component is present can be determined and the case (FIG. 5C) in which whether a multi-path interference component is present cannot be determined based on changes in the intensities of reflection modulation signals according to distances of the reflection modulation signals by using four sampled points having different phases.

The probability that a sample may be included in the distortion section increases when a reflection modulation signal has a higher frequency. As described as an example with reference to FIG. 5, this corresponds to a case in which a signal has been actually distorted due to a multi-path interference component. In order to prevent such a case from being not detected, a modulation signal having a relatively high frequency may be used that is sensitive to a multi-path interference component.

FIG. 3B illustrates an image having a difference between absolute values of the amplitude of two reflection modulation signals having frequencies of 20 MHz and 100 MHz. It may be seen that in the depth image of FIG. 3B, a distortion area has a brighter color than a non-distortion area.

Referring back to FIG. 2, the step 240 of generating the confidence map may be performed when it is determined that distortion attributable to a multi-path interference component is present (YES in 230) in the step 230 of determining multi-path distortion. Distortion image data including a distortion area may be generated based on a difference between the offset of a reflection modulation signal corresponding to a modulation signal that is relatively sensitive to a multi-path interference component (for example, a reflection of a higher-frequency modulation signal such as the 100 MHz modulation signal of FIG. 3A) and the amplitude of a reflection modulation signal that is less sensitive to a multi-path interference component (for example, a reflection of a lower-frequency modulation signal such as the 20 MHz modulation signal of FIG. 3A). The confidence map may be calculated as a reciprocal of the distortion image data.

The inside of the square annotation to the confidence map in FIG. 3C is an area in which severe distortion occurred.

It was found that a distortion area included in a reflection modulation signal can be identified in the confidence map that is generated through such a process.

When correcting image distortion attributable to a multi-path interference component that influences the generation of a reflection modulation signal, if the aforementioned confidence map is used, efficiency can be improved in terms of a processing time that is taken for a correction task and an economical aspect, because some distortion area of some of images (and not the entirety of said images) can be selectively corrected.

If data v obtained by a ToF camera has an accurate phase and amplitude (or intensity) without including a multi-path interference component, data v′ reconstructed by using the data v may be matched with the data v obtained by the ToF camera. However, distortion may inevitably occur in the reconstructed depth image because a multi-path interference component, for example, when an indirect reflection component is present.

As will be described below, the present disclosure describes a technology capable of correcting a distorted image portion that is included in a depth image, by dividing a reflection component that is included in a reflection modulation signal into a direct reflection component and an indirect reflection component and generating a depth image by incorporating the direct reflection component, the indirect reflection component, and a total variation (TV) into a cost function having the direct reflection component and the indirect reflection component as a model.

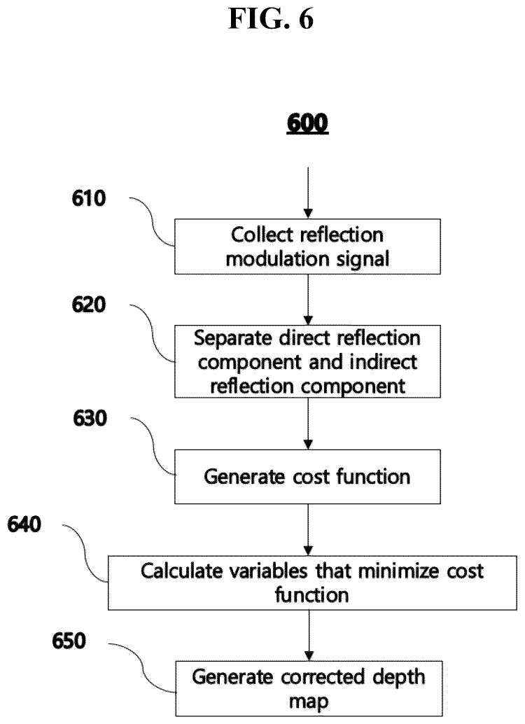

FIG. 6 is an embodiment of a process for correcting a multi-path interference component in a ToF camera according to the present disclosure.

Referring to FIG. 6, a process 600 of correcting a multi-path interference component in a ToF camera (hereinafter referred to as an “interference component correction process”) according to the present disclosure may include a step 610 of collecting a reflection modulation signal, a step 620 of separating a direct reflection component and an indirect reflection component, a step 630 of generating a dual path model, a step 640 of optimizing the dual path model, and a step 650 of generating a corrected depth map. In embodiments, the dual path model is expressed as a cost function.

In step 610 of collecting the reflection modulation signal, the reflection modulation signal including a direct reflection component and an indirect reflection component may be collected. In the present disclosure, assuming that a path along which multi-path interference occurs includes two paths in a reflection path, such as a direct reflection path and an indirect reflection path, a process of setting and optimizing the dual path model will be described. Another path other than the direct reflection path and the indirect reflection path may be actually present, but the influence of another path on the distortion of an image may be neglected compared to values of the direct reflection path and the indirect reflection path.

In step 620 of separating the direct reflection component and the indirect reflection component, reflection components that are included in the reflection modulation signal collected in step 610 of collecting the reflection modulation signal may be separated into a direct reflection component and an indirect reflection component.

The direct reflection component may be a reflection signal component that returns to a light source after being directly reflected by a subject, and may be an important factor that is used to generate a ToF depth image. In contrast, the indirect reflection component may be a reflection signal component that returns to a light source after being reflected by a surrounding object at least once more after being primarily reflected by a subject, and may be a factor that causes distortion when a ToF depth image is generated.

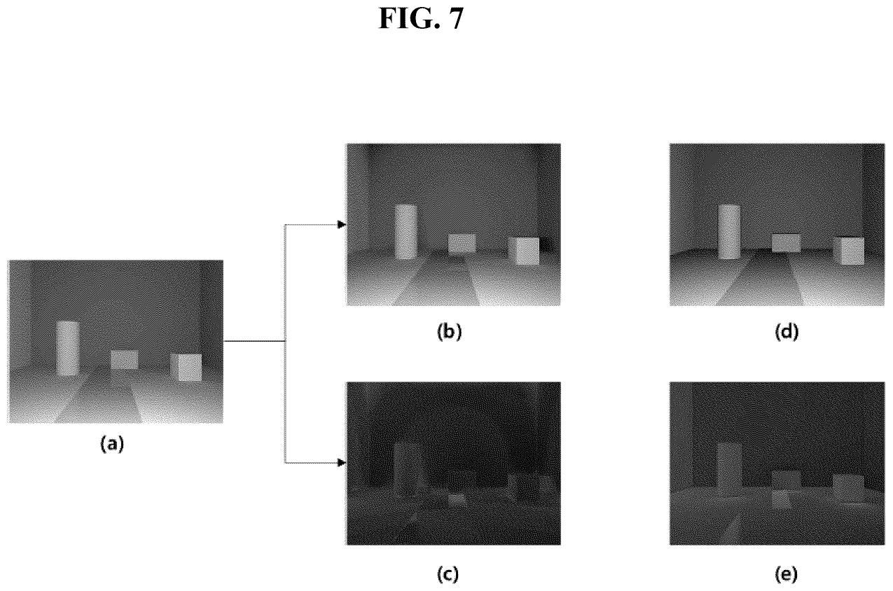

FIG. 7 illustrate examples of (a) an image that was produced by a ToF camera, (b) a direct reflection component and (c) an indirect reflection component that are separated from each other, and (d) a direct ground truth component and (e) an indirect ground truth component that are separated from each other.

FIG. 7A illustrates an image of a subject that was monitored by the ToF camera. FIG. 7B illustrates an image of the direct reflection component that was separated from the image of the subject monitored by the ToF camera. FIG. 7C illustrates an image of the indirect reflection component that was separated from the image of the subject monitored by the ToF camera. FIG. 7D illustrates a reference image, that is, a direct ground truth image of the subject. FIG. 7E illustrates an indirect ground truth image of the subject.

As described above, assuming that the direct reflection component and the indirect reflection component are major components in the reflection modulation signal, reconstructed k (k is a natural number)-th frame data (v̅ₖ) may be represented as an Euler's formula periodic function using the intensity and length of a direct reflection path, the intensity and length of an indirect reflection path, and the wavelength and phase shift of a k-th frame, as in Equation 4.

$${\hat{v}}_{k} = {a}_{1} {e}^{( \frac{2 π {d}_{1}}{{λ}_{k}} + {ϕ}_{k} ) i} + {a}_{2} {e}^{( \frac{2 π {d}_{2}}{{λ}_{k}} + {ϕ}_{k} ) i} \qquad ( 4 )$$

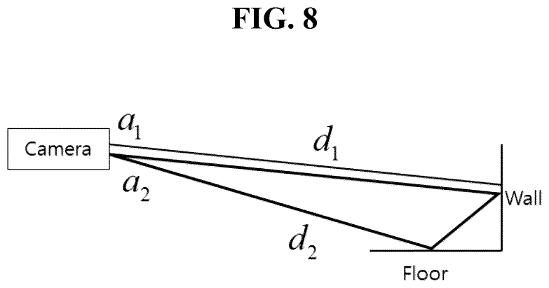

FIG. 8 illustrates variables that are defined between a camera and a subject.

Referring to FIG. 8, in Equation 4, a₁ may mean the amplitude (or intensity) of the direct reflection path, a₂ may mean the amplitude of the indirect reflection path, d₁ may mean the length of the direct reflection path, may mean the length of the indirect reflection path, λₖ may mean the wavelength of the k-th frame, Φₖ may mean the phase shift of the k-th frame, and i represents an imaginary number corresponding to the positive square root of −1.

The first term (a₁e^{(2πd}^{₁}^{/λ}^{ₖ}^{+ϕ}^{ₖ}^{)t}) on the right side of Equation 4 may correspond to the direct reflection component. The second term (a₂e^{(2πd}^{₁}^{/λ}^{ₖ}^{+ϕ}^{ₖ}^{)t}) on the right side of Equation 4 may correspond to the indirect reflection component.

Since the direct reflection component and the indirect reflection component are components included in the reflection modulation signal, the amplitude (a₁) of the direct reflection component and the amplitude (a₂) of the indirect reflection component may be represented as in Equation 5 in relation to Equation 2.

$$Q = Q 1 + Q 3 = Q 2 + Q 4 = {a}_{1} + {a}_{2} \qquad ( 5 )$$

In Equation 5, the amplitude (a₂) of the indirect reflection component may be represented as in Equation 6 by using the amplitude (a₁) of the direct reflection component and the four samples Q1 to Q4.

$${a}_{2} = \frac{{Q}_{1} + {Q}_{2} + {Q}_{3} + {Q}_{4}}{2} - {a}_{1} \qquad ( 6 )$$

Referring to Equations 5 and 6, it may be seen that the number of unknown values can be reduced from four (i.e., a₁, a₂, d₁, and d₂) to three (i.e., a₁, d₁, and d₂).

In step 630 of generating the dual path model, a cost function (C/F) including a data term and a normalization term may be generated based on the direct reflection path and the indirect reflection path. Generating the cost function may be considered generating the dual path model in that the cost function is based on the direct reflection path and the indirect reflection path.

The cost function (C/F) may be represented as in Equation 7.

$$C / F = {‖ {v}_{k} - {\hat{v}}_{k} ‖}_{2}^{2} + {γ}_{1} TV ( {d}_{1} ) + {γ}_{2} TV ( {a}_{1} ) \qquad ( 7 )$$

The first term (∥vₖ−\hat{v}ₖ∥₂²) on the right side of Equation 7 may be the data term. The second term (γ₁TV(d₁)+γ₂TV(a₁)) on the right side of Equation 7 may be the normalization term. Penalty constants γ₁ and γ₂ may be empirically determined values, and may have values of 0.0025 and 0.001, respectively.

The data term (∥vₖ−\hat{v}ₖ∥₂²) is a term for calculating a difference between k-th frame data vₖ) that is measured by a ToF camera using the direct reflection component and the indirect reflection component as a model and reconstructed k-th frame data (\hat{v}ₖ). The reconstructed k-th frame (\hat{v}ₖ) data is indicated in Equation 4.

Equation 7 cannot be solved by using only the data term because there is only the one equation, but the number of variables of the equation are three (i.e., a₁, d₁, and d₂). In the present disclosure, in order to find a solution of Equation 7, the normalization term is added.

In the normalization term (γ₁TV(d₁)+γ₂TV(a₁)), a total variation (TV) may be represented as in Equation 8.

$$TV ( u ) = {\int }_{Ω} \vert ∇ u \vert dx \qquad ( 8 )$$

The TV may be an algorithm that is used in the image field. In Equation 8, u may indicate a variable of the TV algorithm, may indicate the differential of u, and Ω may indicate the entire image area.

The normalization term may be a value that is obtained by combining the amplitude (a₁) of the direct reflection path and the length (d₁) of the direct reflection path, after applying the TV algorithm to the amplitude (a₁) of the direct reflection path and the length (d₁) of the direct reflection path and then applying penalty constants (γ₁ & γ₂) to the amplitude (a₁) of the direct reflection path and the length (d₁) of the direct reflection path, respectively.

In step 640 of optimizing the dual path model, the three variables (\hat{d}₁, \hat{d}₂, and â₁) indicated in Equation 7 may be used to calculate a value that minimizes the cost function (C/F). Since the cost function is the dual path model as described above, the step 640 may be considered a dual model optimization step.

An equation for calculating the variables that minimize the cost function (C/F) may be represented as in Equation 9.

$$( {\hat{d}}_{1} , {\hat{d}}_{2} , {\hat{a}}_{1} ) = {arg min}_{{d}_{1} , {d}_{2} , {a}_{1}} [ {‖ {v}_{k} - ( {a}_{1} {e}^{( \frac{2 π {d}_{1}}{{λ}_{k}} + {ϕ}_{k} ) i} + {a}_{2} {e}^{( \frac{2 π {d}_{2}}{{λ}_{k}} + {ϕ}_{k} ) i} ) ‖}_{2}^{2} + {γ}_{1} TV ( {d}_{1} ) + {γ}_{2} TV ( {a}_{1} ) ] \qquad ( 9 )$$

In this case, “argmin” may mean that the variables (\hat{d}₁, \hat{d}₂, and â₁) that minimize an equation within parentheses [ ] in Equation 9 are found.

In step 650 of generating the corrected depth map, the corrected depth map may be generated by applying the three variables (\hat{d}₁, \hat{d}₂, and â₁) that minimize the cost function to the depth image including the direct reflection component and the indirect reflection component.

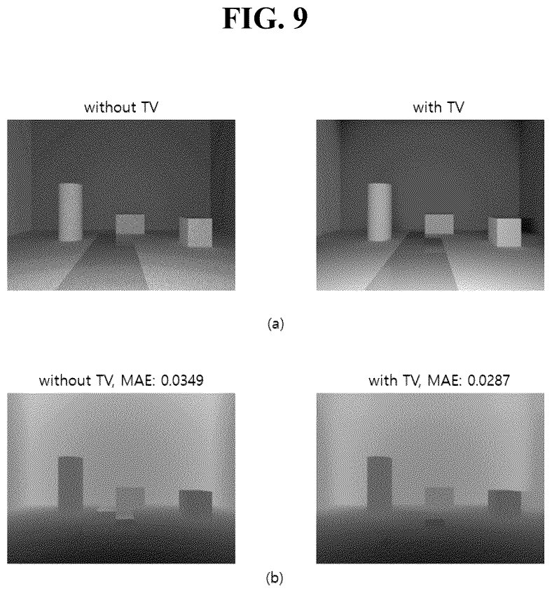

FIG. 9 includes images illustrating a comparison between depth images depending on whether a TV has been applied to a dual path model according to the present disclosure.

FIG. 9A illustrates a comparison between the influences of TVs on the amplitude of a direct reflection component. It may be seen that the amplitude of the direct reflection component includes more noise in a case in which a TV is not present (“without TV” on the left side of FIG. 9A) than in a case in which a TV is present (“with TV” on the right side of FIG. 9A).

FIG. 9B illustrates a comparison between the influences of TVs on a depth image. More noise is included in a case in which a TV is not present (“without TV”, Mean Absolute Error (MAE): 0.0349 on the left side of FIG. 9B) than in a case in which a TV is present (“with TV”, MAE: 0.0287 on the right side of FIG. 9B). Accordingly, it may be seen that distortion attributable to a dual path interference component was not properly corrected.

For the reason why the cost function indicated in Equation 7 is based on the direct reflection path and the indirect reflection path and the TV algorithm has been applied to the data term and the normalization term, and effects thereof, reference may be made to the description given with reference to FIG. 9.

An image illustrated on a lower side of FIG. 9B on the right side thereof is an example of the corrected depth map.

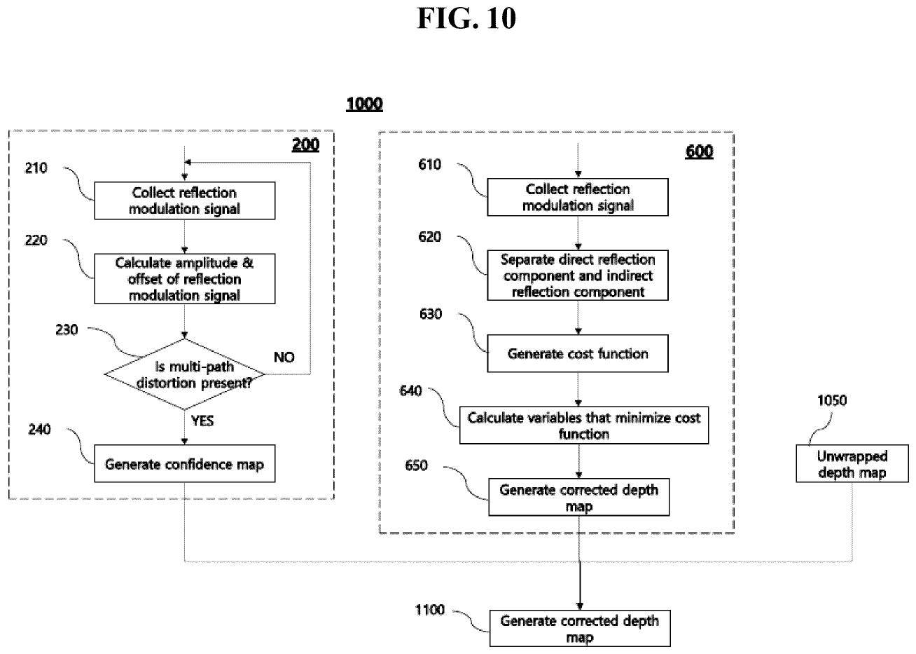

FIG. 10 illustrates another embodiment of a process for correcting a multi-path interference component in a ToF camera according to the present disclosure.

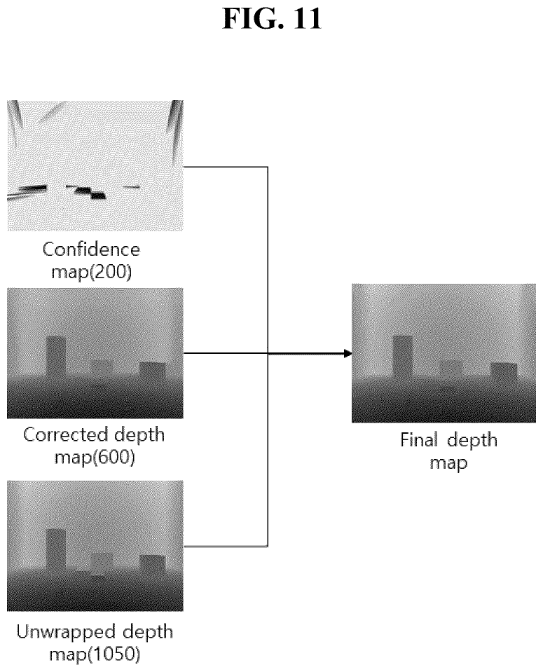

FIG. 11 illustrates the process for correcting a multi-path interference component in a ToF camera, which is illustrated in FIG. 10, with a depth image.

Referring to FIGS. 10 and 11, in a process 1000 of correcting a multi-path interference component in a ToF camera according to the present disclosure, a final depth map may be generated at step 1100 by applying the confidence map obtained by the process 200 of detecting a multi-path interference phenomenon in a ToF camera, which has been described with reference to FIG. 2, to the corrected depth map obtained by the process 600 of correcting a multi-path interference component in a ToF camera, which has been described with reference to FIG. 6, and an unwrapped depth map 1050 including a direct reflection component and an indirect reflection component.

The present disclosure proposes two types of processes for correcting a multi-path interference component in a ToF camera.

The first process may correct a depth map by separating components including a direct reflection component and an indirect reflection component and applying the separated components to the dual path model by using the process described with reference to FIG. 6.

The second process may generate a confidence map that specifies an area including distortion attributable to a multi-path interference component by using the process 200 described with reference to FIG. 2 and then correct the area including distortion attributable to the multi-path interference component by applying the confidence map to the unwrapped depth map 1050 including a direct reflection component and an indirect reflection component and the corrected depth map obtained by the distortion phenomenon correction process 600 described with reference to FIG. 6.

The second process may have advantages in that the correction of a depth map can be maximized while minimizing the time and expenses necessary for the correction because the entire depth map is not corrected, and instead an area of the depth map in which a distortion phenomenon actually occurs is selected and the depth map in the selected area is corrected.

In FIG. 10, the unwrapped depth map may be a depth map that is generated by using data of an image obtained by a ToF camera, which has been measured at four different phases. The unwrapped map may include both a direct reflection component and an indirect reflection component.

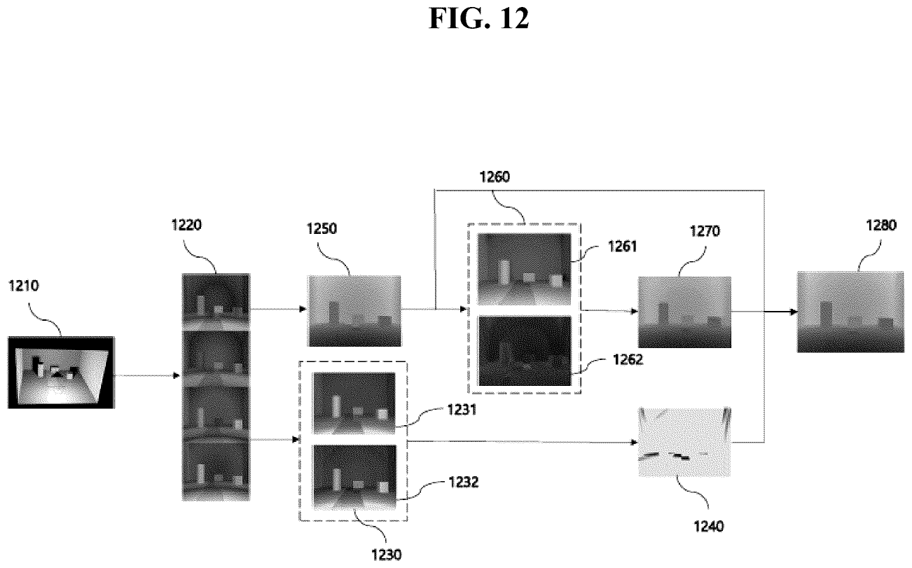

The entire construction of the present disclosure is described with reference to FIG. 12, based on the premise that an image 1210 of an actual subject, which was captured by a ToF camera, is measured (1220) at four different phases.

Reflection modulation signals having two different frequencies (1230), that is, a first frequency reflection modulation signal 1231 and a first frequency reflection modulation signal 1232, are obtained from the images 1220 measured at the four different phases. A confidence map 1240 including an area in which distortion occurred is generated by using a reflection modulation signal having a relatively high frequency.

An unwrapped depth map 1250 is generated from the images 1220 measured at the four different phases. A direct reflection component 1261 and an indirect reflection component 1262 that are included in the unwrapped depth map 1250 are separated from each other (1260). A depth map 1270 that has been corrected by applying the unwrapped depth map 1250 to the dual path model is generated.

Distortion of the corrected depth map 1270 has been corrected to some extent. However, for a more effective correction, a final depth map 1280 may be generated by applying a confidence map 1240 to the unwrapped depth map 1250 and the corrected depth map 1270.

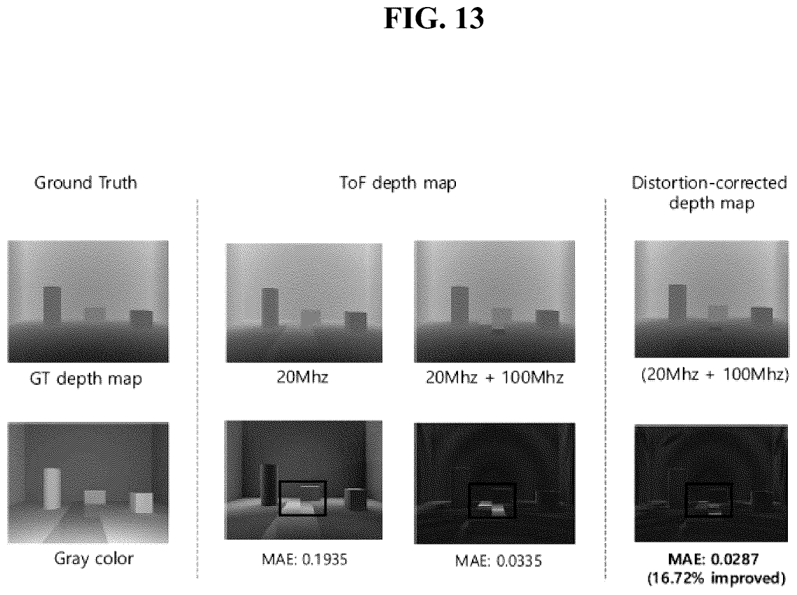

FIG. 13 illustrates a comparison between the results of the process for detecting a multi-path interference component in a ToF camera and the process for correcting a multi-path interference component in a ToF camera according to the present disclosure in the form of images.

A reference image (ground truth), a ToF depth image, and a distortion-corrected depth map are illustrated in order of the left, the middle, and the right in FIG. 13.

For detailed descriptions of the images illustrated in FIG. 13 and a comparison between the images, reference may be made to the description given with reference up to FIG. 12. In this case, the inside of a square indicated in each of three images on a lower side of FIG. 13 on the right side thereof indicates an example of a point at which distortion occurred.

The technical spirit of the present disclosure has been described above with reference to the accompanying drawings, but merely illustrates some embodiments of the present disclosure and is not intended to limit the present disclosure. Furthermore, it is evident that a person having ordinary knowledge in the art to which the present disclosure pertains may modify and imitate the present disclosure in various ways without departing from the category of the technical spirit of the present disclosure.

What is claimed is:

1. A method of detecting a multi-path interference component in a time-of-flight (ToF) camera, the method comprising:
collecting a reflection modulation signal emitted from a light source that returns to the ToF camera after being reflected by a subject at a plurality of different times, when two modulation signals having different frequencies are emitted from the light source to the subject;
calculating a measured amplitude and an offset of the collected reflection modulation signal;
calculating a predicted amplitude of the reflection modulation signal using a value of the offset;
determining whether the multi-path interference component is included in the collected reflection modulation signal by comparing the predicted amplitude and the measured amplitude;
generating distortion image data according to a difference between the offset and the measured amplitude of the measured reflection modulation signal; and
generating a confidence map as a reciprocal number of the distortion image data.

2. The method of claim 1, wherein the measured amplitude is an amplitude of a first modulation signal of the two modulation signals that is more sensitive to the multi-path interference component of the reflection modulation signal than a second modulation signal of the two modulation signals.

3. The method of claim 2, wherein the first modulation signal has a higher frequency than the second modulation signal.

4. The method of claim 1, wherein determining whether the multi-path interference component is included in the measured reflection modulation signal comprises determining that multi-path distortion is present in the collected reflection modulation signal when the amplitude of the predicted reflection modulation signal and the amplitude of the measured reflection modulation signal are different from each other.

5. The method of claim 1, wherein:
the reflection modulation signal comprises four reflection modulation signals each having a phase difference of 90° each other, and
the amplitude of the reflection modulation signal and the offset of the reflection modulation signal are calculated using intensities of the four reflection modulation signals.

6. A method of correcting a multi-path interference component in a time-of-flight (ToF) camera, the method comprising:
collecting a reflection modulation signal corresponding to a modulation signal emitted by a light source towards a subject when the reflection modulation signal returns to the ToF camera after being reflected by the subject;
separating a direct reflection component produced via a direct reflection path, which is included in the reflection modulation signal, and an indirect reflection component produced via an indirect reflection path, which is included in the reflection modulation signal, from each other;
generating a dual path model by generating a cost function comprising a data term and a normalization term, based on the direct reflection path and the indirect reflection path;
optimizing the dual path model by calculating values of a plurality of variables that minimize the cost function; and
generating a corrected depth map by applying the values of plurality of variables to a depth image comprising the direct reflection component and the indirect reflection component,
wherein the data term is a term for calculating a difference between k-th frame data that is measured by the ToF camera using the direct reflection component and the indirect reflection component as a model and reconstructed k-th frame data, where k in a natural number, and
wherein the normalization term comprises a value that is determined according to an amplitude of the direct reflection path and a length of the direct reflection path, after applying a total variation (TV) algorithm to the amplitude of the direct reflection path and the length of the direct reflection path and then applying penalty constants to the amplitude of the direct reflection path and the length of the direct reflection path, respectively.

7. The method of claim 6, wherein the reconstructed k-th frame data is an equation for representing the amplitude and the length of the direct reflection path, an amplitude and a length of the indirect reflection path, and a wavelength and a phase shift of the k-th frame by using an Euler's formula periodic function.

8. The method of claim 7, wherein optimizing the dual path model further comprises substituting one of the intensity of the direct reflection path and the intensity of the indirect reflection path with a relation equation between the other of the intensity of the direct reflection path and the intensity of the indirect reflection path and amplitudes of reflection modulation signals collected at four different times.

9. A method of correcting a multi-path interference component in a time-of-flight (ToF) camera, the method comprising:
generating a final depth map by applying a confidence map to a depth map and an unwrapped map,
wherein the depth map is generated by calculating variables that minimize a cost function comprising a data term and a normalization term, based on a reflection modulation signal that comprises a direct reflection component and an indirect reflection component and that is generated when a modulation signal that is emitted from a light source to a subject returns to the ToF camera, and applying the variables to the depth image comprising the direct reflection component and the indirect reflection component,
wherein the unwrapped map comprises the direct reflection component and the indirect reflection component,
wherein the emitted modulation signal comprises two modulation signals having respective different frequencies, and
wherein the confidence map is calculated as a reciprocal number of distortion image data, after calculating amplitude and offsets of a plurality of reflection modulation signals collected at a plurality of different times, comparing amplitude of a reflection modulation signal that has been predicted by using a value of the offset and amplitude of a measured reflection modulation signal, and generating the distortion image data into which a difference between the offset and the amplitude of the measured reflection modulation signal has been incorporated.
